(19) United States
(12) Patent Application Publication
(10) Pub. No.: US 2011/0247269 A1
(43) Pub. Date: Oct. 13, 2011

(54) PLANT STARTER KIT AND METHOD

(75) Inventors: Marc W. Cool, Rancho Domingues, CA (US); Bryan W. Ware, Rancho Dominguez, CA (US); Bob B. Allison, Rancho Dominguez, CA (US); Marci E. Needham, Rancho Dominguez, CA (US); Mary T. Morgan, Rancho Dominguez, CA (US)

(73) Assignee: MARS, INC, McLean, VA (US)

(21) Appl. No.: 13/080,828

(22) Filed: Apr. 6, 2011

Related U.S. Application Data
(60) Provisional application No. 61/323,165, filed on Apr. 12, 2010.

(51) Int. Cl. A01G 9/02; A01G 25/00

(52) U.S. Cl. 47/66.7; 47/65.8

(57) ABSTRACT

Kits are disclosed for starting plant seedlings from seeds. The kits can employ self-watering structures and can create microenvironments that foster seed germination and seedling growth. The kits can include structures that minimize the transplanting stress to transplanted seedlings. Methods for growing seedlings from seeds also are disclosed.

### CROSS-REFERENCE TO RELATED APPLICATIONS

This application claims priority to U.S. Provisional Application No. 61/323,165 filed Apr. 12, 2010.

### TECHNICAL FIELD

The invention relates to apparatus and methods useful for germinating seedlings from seeds. More specifically, the invention relates to apparatus and methods which require little user intervention to produce robust seed germination.

### BACKGROUND OF THE INVENTION

Home gardeners often attempt to grow seedlings from seeds, for reasons such as saving money or simply to enhance the home gardening experience.

Successfully growing seedlings from seeds and transplanting those seedlings to an outdoor or other transplanted environment can be challenging. Seeds require the right environment to germinate, and once germinated and of sufficient size, need to be robust enough to survive the transplanting process.

Germinating seeds indoors in a pot or other container often does not lead to a high yield of healthy seedlings. A home gardener left to her own devices must determine how to provide the correct soil characteristics, plant nourishment, watering and climatic environment to germinate seeds. Once those seeds have germinated, the seedlings must be transplanted without physical damage or other stress which may prevent the seedling from growing robustly in its new environment. Merely placing a seed in a pot and watering it typically will not result in high yields of robust seedlings.

While professional agrarians are aware of generally favorable conditions and systems for germinating seeds, the knowledge and professional apparatus for obtaining high yields of robust seedlings is not available to the average home gardener, and the complications of applying these techniques at home goes far beyond what an average home gardener may wish to engage in.

Even when the most ambitious gardener carefully researches the proper soil and climatic conditions required for germination, creating those conditions at home can be very challenging. Regular tending of the germination process to maintain those conditions also is challenging, given the multitude of demands placed on many home gardeners.

Sadly, given the relatively slow germination process and seasonal variations in planting requirements, any failure to identify, create and regularly maintain the proper growing conditions can mean that the window of opportunity for transplanting home germinated seedlings is typically lost for that gardening season.

What is needed is a reliable kit and method for generating seedlings from seeds that creates and maintains the proper conditions for seed germination and growth with little required attention from home gardeners. Ideally, the kit and method should also render the transfer of germinated seedlings reliable and trouble-free.

### BRIEF SUMMARY OF THE INVENTION

We have developed a self-watering seed-to-seedling plant starter kit that makes it surprisingly easy for home gardeners to successfully start seedlings indoors with a minimum amount of tending and which provides easy outdoor transplanting without damaging seedling roots.

This kit is intended to be particularly useful in a typical home environment, such as on a window sill, and contains a growth media of soil and plant food, in which a seed or seeds are planted. The media and seed are contained within a container, which in some embodiments is specially designed, preferably bio-degradable pouch which rests in a complimentary watering tray, and which includes features which make the pouch easily opened to slide the seedling into the soil in an outdoor environment.

The invention can benefit from a self-watering ability which is a function of growth media volume, water volume, media height in the pouch, and the pouch geometry and placement within the watering tray.

This self-watering ability allows water in the tray to wick up from the watering tray through the media to the media surface to provide proper moisture in the correct area for a germinating seed and growing seedling. Use of the tray also provides for a buffer volume of water so product does not need to be watered each day, and avoids the stress resulting from uneven or missed waterings that often occur in a home gardening environment. Furthermore, the self-watering feature minimizes the danger of certain damping-off fungal diseases which can be caused by improper surface watering.

Additionally, the incubation ability of the kit is in some embodiments enhanced by the unique size and shape of the upper pouch opening and the distance between the growth media surface and the top of the opened pouch, as well the light transmission through a relatively clear pouch top. These features help create a microclimate incubation area at and above the soil surface which is ideal for a seed to germinate, and which, after seed germination, allows the seedling to grow above the level of the pouch opening and be open to air movement necessary for further seedling growth. This feature compares favorably to products containing such features as germination domes, which after germination can be detrimental to indoor seedling growth. Thus, as with the self-watering feature, the microclimate is essentially self-regulating and contributes to the successful generation of robust seedlings, especially in a home use environment.

More specifically, the invention is directed to a plant starter kit have a pouch for containing growth media and one or more seeds; a perforated pouch lower portion for allowing water to wick upwardly into the growth media placed into the pouch; and pouch side walls extending upwardly from the perforated bottom portion to above an upper surface of the growth media, thereby forming a microclimate environment for seed germination and seedling growth. The kit further including a means for allowing the pouch to rest within a water source, thereby allowing water to wick upwardly into the growth media. The pouch includes one or more gussets for causing the perforated pouch lower end portion to rest within water and one or more gussets are an integral part of the pouch.

The kit further including a watering tray for receiving water and at least the lower pouch end portion. The pouch side walls have a height, and the pouch has a filled width measured across a major axis of an upper surface of the growth media, and wherein the height is less than the width. The height is between about one and two inches in height above an upper surface of the growth media and a portion of the sidewalls extending above the upper surface of the growth media is between about one and two inches in height. The pouch also includes a scored bottom end portion for allowing a seedling to be easily transplanted by opening the scored bottom end and allowing the contents of the pouch to slide downwardly from the pouch. The pouch is filled with growth media and has generally vertical sidewalls and a generally open top.

The invention is also directed to a plant starter kit that includes a container means for holding growth media and at least one seed; micro-climate means for maintaining a micro-climate around a seedling germinated from the at least one seed; and self-watering means for self-watering by the penetration of water into the growth media from generally below or beside the seed. The container means is a pouch and the self-watering means provides water to the growth media for at least one week without further addition of water. The micro-climate maintains improved conditions for germination of a seedling from a seed for at least 25 percent of the time from the initial watering of the growth media until transplanting of the germinated seedling.

The container means has a generally open upper area and it has walls defining an area around the growth media and wherein the container means has an opening defined by upper wall edges having a surface area of at least 75 percent of the surface area of a growing media generally confined by the walls. The container means includes a means for allowing a seedling to be easily transplanted by providing an easily opened bottom-means that allows the growth media contents of the container means to slide downwardly in a substantially integral mass from the pouch for transplanting.

The invention is further directed to a method for improving the germination of seedlings from seeds in a home gardening environment comprising the step of: providing a micro-climate enabling, self-watering seed starter kit to a consumer. User intervention from initiation of seed growth until transplanting requires only watering at a minimum of seven day intervals.

Other factors contributing to the successful germination and planting of seedlings in some embodiments of the invention are attributable to user-friendly features of the pouch. The pouch is designed with easy peel-away ends and a perforation across its bottom end surface that can be opened when the seedling is ready to transplant outdoors. This easy, slidable transfer of soil and seedling into a previously made hole or trench minimizes stress to the seedling and its root structure, and allows the seedling to quickly and successfully establish in the soil. Remaining pouch portions in the soil after transplanting will not impede root growth, as the roots will grow under and out the opened bottom.

Thus, the combinations of some or all of the foregoing features provide several embodiments of kit that can be used by gardeners, and especially home gardeners, to yield one or more seedlings from easy transplanting.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective drawing of a plant starter kit in accordance with our invention;

FIG. 2 is a perspective drawing showing additional detail of a pouch used in an embodiment of our invention; and

FIG. 3 is a front plan view of the pouch of FIG. 2 prior to filling with growth growing media and one or more seeds.

### DETAILED DESCRIPTION OF THE INVENTION

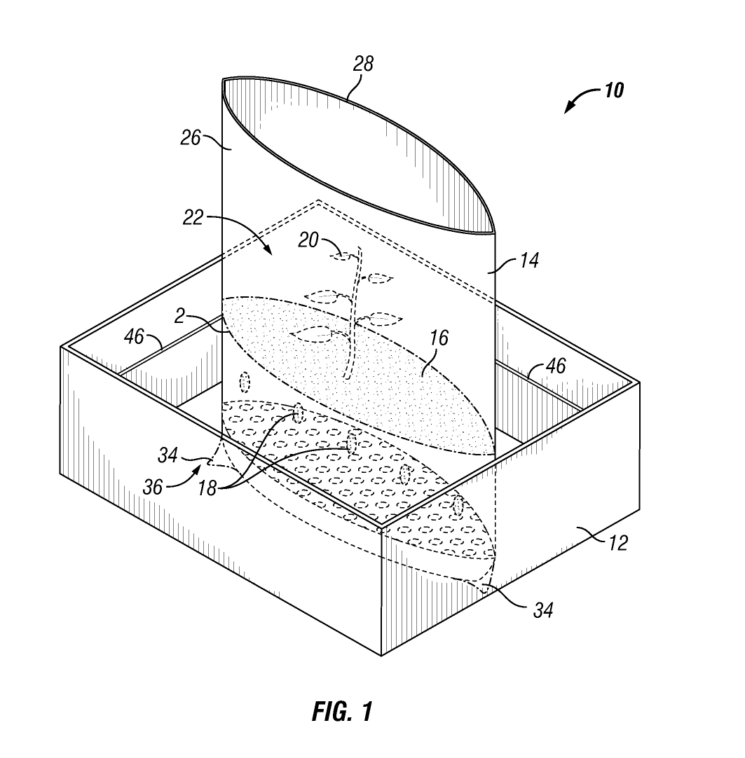

FIG. 1 provides a perspective view of one embodiment of a plant starter kit 10 in its intended use configuration. Kit 10 includes a tray 12 and a pouch 14 filled with growth growing media 16 which contains one or more seeds 18 from which a seedling 20 has germinated.

As will be described in detail below, tray 12, pouch 14 and growth media 16 cooperate to form a microclimate seedling incubation area 22 extending upwardly from the surface level 24 of growth media 16, between sidewalls 26 of pouch 14, to slightly above the top edge 28 of pouch 14.

Incubation area 22 creates an appropriate micro environment for the seed to germinate and start initial growth. Unlike domed or other fully or partially closed covers sometimes used in plant starter applications, area 22 does not trap large amounts of moisture within the incubation area. Trapping excess moisture in the incubation area of a seedling can cause detrimentally high moisture levels, particularly in the later stages of the germination process, which in turn can lead to excessive moisture levels and potential fungal disease.

As used in this application, “micro-climate” or “micro-environment” means a controlled area around a seed or seedling that provides a sheltered environment capable of nurturing germination or growth by maintaining a local region of growing conditions different from, and more desirable than, the ambient conditions otherwise present in the absence of the physical structure enabling the micro climate or environment.

The micro-climate preferably provides a ‘self regulating effect’ in which the temperature and humidity are maintained in a preferable condition during a substantial portion of the germination process. Typical domed-typed covers known in the prior art, if used for a substantial part of the germination cycle, can produce detrimental growing conditions. For example, if plants are exposed to the dome-induced conditions for too long, the environment can encourage the development of plant diseases, and if for too short a period, may not allow the young seedling to develop to the point of being able to survive on its own outside of the micro environment. Additionally, removal by such a cover at a suboptimal time by a gardener can degrade growing conditions even more.

Distance from top of soil to top of pouch and pouch dimensions should be selected to maintain the microenvironment as described above. For tomato seedlings, in a preferred embodiment, the height of pouch sidewall 26 should rise about one inch above media surface level 24 where the dimension of the generally ellipsoidal pouch 14 has a major axis of 6 inches and a minor axis of 3 inches. The media depth in pouch 16 is preferred to be about 4 inches, which is not so much as to prevent the upward movement of the wicking water. These dimensions are generally useful for most garden seedling plants.

Typically, preferred pouch embodiments are wider than they are tall. This configuration permits the pouch to contain enough soil with plant nutrients to feed the plants, but minimizes the height of the growth media column through which water must wick upwardly to the seed and ultimate root structure, which in turn contributes to the consistent watering of the seed and seedling.

For most gardening applications, a preferred sidewall height is between about 1 and 2 inches. As the height is increased above about 2 inches, the pouch may create a humid micro-climate area for too long. Wall heights lower than about 1 inch may not allow the young seedling to develop to the point of being able to survive on its own outside of the micro-climate.

In some embodiments, it is also preferred that the pouch cross section (i.e. looking down through the pouch on the media surface) have a narrow configuration where there is a minor axis and major axis such as with the generally ellipsoidal shape shown in FIG. 1. Major to minor axis ratios of between 2 and 4 are preferred to enhance the micro-climate effect.

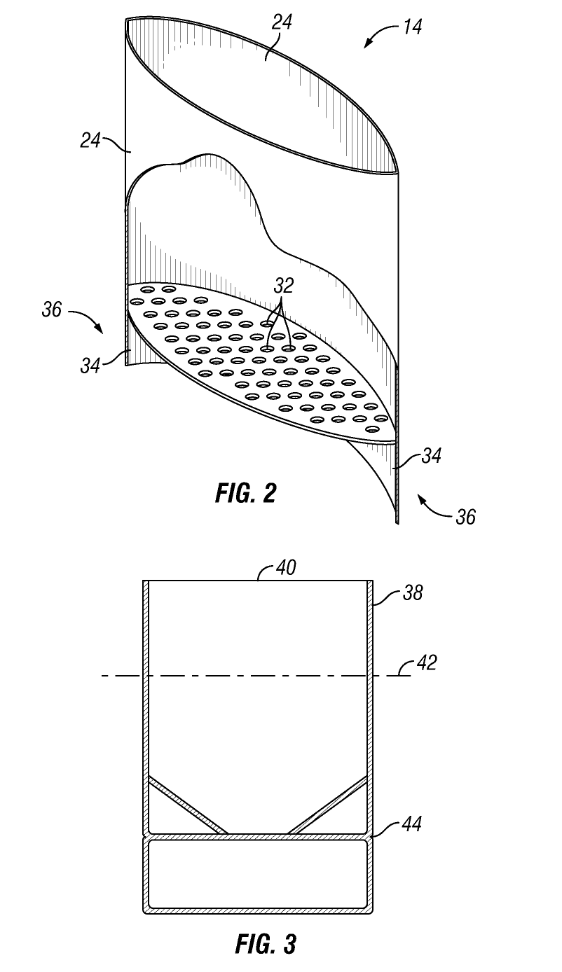

Additional details of pouch 14 are shown in FIG. 2. Pouch 14 is depicted in its expanded in-use configuration as it would appear when filled with media 16 and standing in tray 12. Pouch side walls 24 rise vertically above a perforated pouch bottom 30. Pouch bottom 30 contains a plurality of apertures 32 which are sized and of an appropriate overall open area to retain media 16 while permitting an appropriate amount of water from tray 12 (see FIG. 1) to enter media 16 to permit germination. In this way, the water in tray 12, pouch 14 and growth media 16 cooperate to provide a self watering incubation environment for seeds 18 (see FIG. 1) to germinate.

Pouch 14 preferably is made from a bio-degradable material that will biodegrade in a home garden environment within one growing season.

Pouch 14 also includes gussets 34 at each lower 36 end of pouch 14. Gussets 34 support perforated bottom 30 above the bottom surface of tray 12 (see FIG. 1), thereby allowing water to easily pass through apertures 32. As described in greater detail and shown in FIG. 3, gussets 34 can be formed by sealing the corners of a flat pouch, thereby causing gussets to support perforated bottom 30 when the user expands pouch 14. Preferably, gussets 34 should keep the lower surface of perforated bottom 30 at least one quarter of an inch above the bottom surface of tray 12. Although the use of gussets integral to the pouch design is not necessary to practice the invention, it is required that the pouch be perforated at or near its bottom end surface, and that sufficient water envelope the perforated portion of the pouch to allow water to wick up in the self-regulated manner described. Thus, in the absence of gusset structures, some other mechanical means should be used to maintain the separation of the perforated surface from an adjacent solid surface such as the bottom of tray 12.

Apertures 32, as shown in the Figures, are nominally 0.085 inches in diameter, are in a staggered arrangement and are located in perforated bottom 30 about 0.219 inches apart. Generally, aperture size should be selected to prevent media particles from falling through apertures 32 while allowing water to wick into media 16 when pouch 14 is placed into filled tray 12. Suitable aperture sizes typically range from 0.1-0.05 inches in diameter but may vary within and outside of this range depending on the media selected. Generally, the open surface area formed by apertures 32 should preferably constitute between about 20 and 35 percent of the total surface area of perforated pouch bottom 30, and optimally about 30 percent.

A useful ratio of growth media to water is 1:1, and for the specific size described in the paragraph above, about two cups of each is preferred. In this case, two cups of soil provides enough nutrients for the seedling to grow without needing to supplement fertilizer, and two cups of water is enough to water the seedling for approximately one week.

Growth media should be soil, such as granulated peat enriched or charged with organic fertilizer and nutrients, and can contain up to 25% perlite or vermiculite or a combination thereof.

FIG. 3 depicts pouch 14 after production but prior to filling with growth growing media 16. Pouch 14 is formed from two identical layers of material joined at the shaded area 38 by a heat or other seal. This seal preferably is easily peelable for later transplantation of seedling 20.

Pouch 14 also includes a flat cut opening 40 to allow media to be added to pouch 14 at its upper end, as well as a first laser score 42 and a second laser score 44 across both layers of pouch 14. As provided to the user, pouch 14 is closed with media 16 added to pouch 14, and the user tears open pouch 14 at score 42 to begin the germination process, and score 44 to open the perforated pouch bottom 30 to prepare pouch 14 for transplanting outdoors or other transplanted environment.

It should be noted that scoring can be accomplished by any other suitable means known in the pouch fabrication art, such as by mechanical scoring or any other means that lets the pouch be opened for use or transplanting as described above.

Tray 12 also includes a fill line 46 (see FIG. 1) used to instruct the user of the starter kit as to the optimal amount of water to be added to the kit. Typically this fill line should be selected so that when used in combination with pouch 14 or other equivalent container, the kit is self-watering for a period of at least a week, or longer.

The preferred embodiment described above is just one form of the invention. Other embodiments of the invention, that exploit the micro-climate and self-watering advantages of the invention, can be made using a variety of containers and trays or their functional equivalents. The preferred embodiments of the invention merely need to include sufficient physical apparatus to contain the growing media, to create and maintain a micro-climate and to be self-watering for a sufficiently long period to provide germination advantages for the seed and seedling.

Thus, the invention also includes any embodiment using: a container means for holding growth media and at least one seed;

a micro-climate means for maintaining a microclimate around the seedlings for a substantial period (i.e. greater than fifty percent, and preferably greater than 70 percent) of the time from the initial watering of the growth media until transplanting of the germinated seedling; and

a self-watering means sufficient to allow the growth media to be self-watering by the penetration of water from generally below or beside the seed location so as to cause water uptake near the seed, to be regulated exclusively or primarily by the wicking action of the growth media, preferably for at least one week without refilling a reservoir associated with the self-watering means (such as the tray illustrated above).

The micro-climate means can, for example, be formed from any flexible or hard material that can maintain sufficient physical rigidity or be reinforced to provide a generally rigid structure that maintains the micro-climate and which has sufficient moisture barrier properties to maintain a humidity differential within the micro-climate. Plastic films, woven natural or synthetic materials, paper products and various rigid polymers all may be used to advantage in our invention. Although the micro-climate walls preferably are clear, translucent or even opaque materials can be used where sufficient light reaches the plant seedling to maintain healthy growth.

Walls of the micro-climate means can be any physical shape that can be demonstrated to provide the micro-climate conditions described above, but do not include enclosed containers shapes or configurations that that can cause detrimentally high moisture levels, particularly in late stages of the germination phase. In the preferred embodiments, the container upper area will be generally open (i.e. having an opening at the upper wall having a surface area at of least 50%, and preferable 75%, of the surface area of the growing media).

Self-watering means useful in the invention can be made from any barrier material having sufficiently low soil porosity to maintain the growing media within a specified area, and sufficient permeability to water to allow water to migrate from around the seedling laterally or from below primarily by a wicking action, preferably primarily from below. Many materials meet this criteria, for example woven natural or plastic materials such as polymeric fabrics, burlap or the like. Similarly, generally impermeable materials may be used if holes of sufficiently small size to maintain the growth media, but allow water permeability, are added to the material. For example, generally impermeable papers, metals or plastics may be used in this way.

The container means preferably includes a bottom-opening transplanting means for allowing a seedling to be easily transplanted by allowing the bottom of the container means to be opened or removed by the use of perforations, or separable bottom container portions, such as a screw-off or zip-lock or other removably fastened structure, to allow the growth media contents of the container means to slide downwardly in a substantially integral mass from the pouch for transplanting. This bottom-opening means thereby minimizes or eliminates stress to the seedling root system otherwise often incurred by having to remove the contents of a container such as by digging or spilling.

Using the inventive method, for improving the germination of seedlings from seeds in a home gardening environment by providing a micro-climate enabling, self-watering seed starter kit to a consumer, substantially improves the yield of robust seedlings for use in home gardening projects when compared to other kits known in the art. Specifically, the micro-climate feature, the self-watering feature and the easy transplanting feature each contributes to the successful germination and transplanting seedlings, potentially improving the seedling growth success rate by 25 or even as much as 50 percent or more over kits that require regular watering, use non-micro-climate enclosures as defined herein, or fail to provide for easy transplanting of generated seedlings.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

### LISTING OF REFERENCE NUMBERS

10 plant starter kit
12 tray
14 pouch
16 growth growing media
18 seeds
20 seedling
22 microclimate seedling incubation area
24 surface level of growth media
26 sidewalls
28 top edge of pouch
30 pouch bottom
32 apertures
34 gussets
36 lower end of pouch
38 material joined at shaded areas
40 flat cut opening
42 first laser score
44 second laser score
46 fill line

What is claimed is:

1. A plant starter kit comprising:
a pouch for containing growth media and one or more seeds;
a perforated pouch lower portion for allowing water to wick upwardly into the growth media placed into the pouch; and
pouch side walls extending upwardly from the perforated bottom portion to above an upper surface of the growth media, thereby forming a microclimate environment for seed germination and seedling growth.

2. The kit of claim 1, further including a means for allowing the pouch to rest within a water source, thereby allowing water to wick upwardly into the growth media.

3. The kit of claim 1, wherein the pouch includes one or more gussets for causing the perforated pouch lower end portion to rest within water.

4. The kit of claim 3, wherein one or more gussets are an integral part of the pouch.

5. The kit of claim 1, further including a watering tray for receiving water and at least the lower pouch end portion.

6. The kit of claim 1, wherein the pouch side walls have a height, and the pouch has a filled width measured across a major axis of an upper surface of the growth media, and wherein the height is less than the width.

7. The kit of claim 6, wherein the height is between about one and two inches in height above an upper surface of the growth media.

8. The kit of claim 1, wherein a portion of the sidewalls extending above the upper surface of the growth media is between about one and two inches in height.

9. The kit of claim 1, wherein the pouch includes a scored bottom end portion for allowing a seedling to be easily transplanted by opening the scored bottom end and allowing the contents of the pouch to slide downwardly from the pouch.

10. The kit of claim 1, wherein the pouch filled with growth media has generally vertical sidewalls and a generally open top.

11. A plant starter kit comprising:
container means for holding growth media and at least one seed;
micro-climate means for maintaining a micro-climate around a seedling germinated from the at least one seed; and
self-watering means for self-watering by the penetration of water into the growth media from generally below or beside the seed.

12. The kit of claim 11, wherein the container means is a pouch.

13. The kit of claim 11, wherein the self-watering means provides water to the growth media for at least one week without further addition of water.

14. The kit of claim 11, wherein the micro-climate maintains improved conditions for germination of a seedling from a seed for at least 25 percent of the time from the initial watering of the growth media until transplanting of the germinated seedling.

15. The kit of claim 11, wherein the container means has a generally open upper area.

16. The kit of claim 15, wherein the container means has walls defining an area around the growth media and wherein the container means has an opening defined by upper wall edges having a surface area of at least 75 percent of the surface area of a growing media generally confined by the walls.

17. The kit of claim 15, wherein the container means includes a means for allowing a seedling to be easily transplanted by providing an easily opened bottom-means that allows the growth media contents of the container means to slide downwardly in a substantially integral mass from the pouch for transplanting.

18. A method for improving the germination of seedlings from seeds in a home gardening environment comprising the step of: providing a micro-climate enabling, self-watering seed starter kit to a consumer.

19. The method of claim 18, wherein user intervention from initiation of seed growth until transplanting requires only watering at a minimum of seven day intervals.
